(19) United States
(12) Patent Application Publication
(10) Pub. No.: US 2004/0057719 A1
(43) Pub. Date: Mar. 25, 2004

(54) Solid state image pick-up device and camera using the solid state image pick-up device

(75) Inventors: Masanori Ogura, Kanagawa (JP); Fumihiro Inui, Kanagawa (JP); Tetsuya Itano, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/664,918

(22) Filed: Sep. 22, 2003

(30) Foreign Application Priority Data
Sep. 20, 2002 (JP) 2002-275950
Aug. 4, 2003 (JP) 2003-285888

(51) Int. Cl. G06K 9/00; G03B 17/00

(52) U.S. Cl. 396/439; 382/162; 382/312

(57) ABSTRACT

To suppress an influence exerted on an output video signal due to a high frequency noise from a scanning circuit. In a solid state image pick-up device including horizontal scanning circuits, and a vertical scanning circuit having a lower driving frequency than those of the horizontal scanning circuits which are arranged so as to be adjacent to different side portions of a square chip, pads are arranged at side portions of the chip, except for the side portions on the sides where the horizontal scanning circuits are arranged. The pads include pads through which a voltage or a ground potential is applied to active elements of pixels of a pixel region, pads through which voltages are inputted to amplifiers, and pads through which output signals of the amplifiers are outputted to the outside of the chip.

### BACKGROUND OF THE INVENTION

1. Field of the Invention

The present invention relates to a solid state image pick-up device for use in a digital camera or a video camera.

In addition, the invention relates to a camera using the above solid state image pick-up device.

2. Related Background Art

A solid state image pick-up device has functions of carrying out photoelectric conversion, storage, and reading (scanning) of charges in respective pixels which are two-dimensionally arranged in a pixel region. In recent years, various chip structures in which those functions are incorporated on one-chip have been provided in accordance with introduction of a semiconductor process. FIGS. 7A and 7B show an example of a chip structure of a conventional solid state image pick-up device described in JP 8-256296 A (refer to page 2 and FIGS. 3 and 4).

FIG. 7A is a plan view showing the chip structure of the conventional solid state image pick-up device, and FIG. 7B is a cross sectional view taken along the line 7B-7B of FIG. 7A. This solid state image pick-up device is structured so that a solid state image pick-up element (chip) 101 including a pixel region 102 having pixels two-dimensionally arranged therein is accommodated in a package 100. The pixel region 102 is provided in the vicinity of the center of the solid state image pick-up element 101, and its aspect ratio (ratio of a length to a width) is 3:4, for example. A plurality of pads 105 are provided so as to be adjacent to each a long side of the pixel region 102.

The package 100 includes an opening portion of a predetermined size at the center thereof. A die pad 103 to which the solid state image pick-up element 101 is to be fixed is provided in a recess portion formed in a bottom face of the opening portion. A plurality of pads 107 corresponding to the pads 105 of the solid state image pick-up element 101 fixed onto the die pad 103, respectively, are formed on the bottom face of the opening portion of the package 100. The opening portion of the package 100 is covered with a transparent glass plate 104 to allow the solid state image pick-up element 101 accommodated in the inside of the opening portion to be tightly sealed.

The plural pads 105 formed on the side of the solid state image pick-up element 101 are respectively connected to the plural pads 107 formed on the side of the package 100 by utilizing a wire bonding technique. Also, the pads 107 are respectively connected to a plurality of terminals 106 provided in an outer peripheral portion of the package 100 through predetermined metallic wirings (not shown).

Although not illustrated in FIGS. 7A and 7B, a vertical scanning circuit, a horizontal scanning circuit, and the like are formed as circuits for carrying out the photoelectric conversion, the storage, and the reading of the charges in the pixels on the periphery of the pixel region 102 on the solid state image pick-up element 101. The vertical scanning circuit is normally arranged closer to a short side of the pixel region 102, while the horizontal scanning circuit is normally arranged closer to the long side of the pixel region 102.

In the solid state image pick-up device structured in a manner as described above, necessary signals and voltages are applied from the outside to the solid state image pick-up element 101 through the corresponding pads 105. Consequently, a signal (video signal) is outputted from the solid state image pick-up element 101 to the outside.

Next, a basic configuration of the solid state image pick-up element will hereinbelow be described in brief. The solid state image pick-up elements are roughly classified into two systems: a MOS (X-Y address) system; and a charge transfer system. Both the systems have been put into practical use. As one example, a schematic configuration of a solid state image pick-up element of the MOS (X-Y address) system described in JP 10-233965 A (refer to page 2 and FIG. 5) is shown in FIG. 8.

In the solid state image pick-up element shown in FIG. 8, a plurality of gate lines 203 and a plurality of vertical signal lines 208 are arranged so as to intersect each other. A photodiode 201 is provided in each of intersections at which the gate lines 203 and the vertical signal lines 208 intersect each other through a vertical switch 204 composed of a MOS transistor to thereby form a pixel. A gate of the vertical switch 204 is operatively connected to the corresponding gate line 203, a source thereof is operatively connected to an output terminal of the corresponding photodiode 201, and a drain thereof is operatively connected to the corresponding vertical signal line 208.

Each of the gate lines 203 is connected to a vertical scanning circuit 202. A horizontal switch 206 composed of a MOS transistor is provided in one end of each of the vertical signal lines 208. A gate of the horizontal switch 206 is operatively connected to a horizontal scanning circuit 205, a source thereof is operatively connected to the corresponding vertical signal line 208, and a drain thereof is operatively connected to an input terminal of an amplification circuit 207.

The vertical scanning circuit 202 is a vertical shift register for selecting rows, and a driving frequency thereof is in a range of several kHz to several tens of kHz. The vertical switch 204 is turned ON or OFF in accordance with a selection signal outputted from the vertical scanning circuit 202. On the other hand, the horizontal scanning circuit 205 is a horizontal shift register for selecting columns, and a driving frequency thereof is several tens of MHz. The horizontal switch 206 is turned ON or OFF in accordance with a selection signal from the horizontal scanning circuit 205.

In the above-mentioned solid state image pick-up element, first of all, during a horizontal blanking time period, a voltage of the gate line 203 of a row selected by the vertical scanning circuit 202 is increased so that all the vertical switches 204 connected to the gate line 203 concerned are turned ON. Then, signal charges are transferred from the photodiodes 201 to the respective vertical signal lines 208 through the vertical switches 204 concerned in an ON state. Thereafter, the horizontal switches 206 are successively turned ON or OFF in accordance with the selection signal outputted from the horizontal scanning circuit 205, and then the signal charges transferred to the respective vertical signal lines 208 are successively amplified by the amplification circuit 207 to be outputted therefrom. With respect to other rows as well, the signal charges are transferred in accordance with the same procedure.

In case where the signal charges are successively read out from the pixels two-dimensionally arranged to be transferred, in general, as in an example shown in FIG. 8, an operation is carried out in such a way that a row is selected by the vertical scanning circuit, and next the pixels belonging to the selected row are successively selected by the horizontal scanning circuit. In this case, the driving frequency of the vertical scanning circuit is so low as to fall within the range of several kHz to several tens of kHz, whereas the driving frequency of the horizontal scanning circuit is so high as to be several tens of MHz. Thus, the horizontal scanning circuit becomes a high frequency noise source to supply the wirings and the pads arranged in the vicinity thereof with high frequency noises. Also, any fluctuation of a signal and an electric potential occurs, which may affect an output video signal, in some cases. In the light of such a situation, the wirings and the pads through which the high frequency noise is easy to exert an influence on the output video signal, e.g., the pads through which a voltage or the ground potential is applied to active elements of the pixels, the pads through which a voltage is applied to an amplifier, the pads through which a video signal is outputted from the amplifier, and the like need to be arranged in positions remote from the horizontal scanning circuit as the high frequency noise source.

However, conventionally, the pads are arranged closer to the long side of the chip (on the side along which the horizontal scanning circuit is arranged) for the reason that pitches of the pads can be lengthened and moreover, a large number of pads can be arranged (refer to FIG. 7A). For this reason, an influence may be exerted on the output video signal due to the above-mentioned high frequency noise in some cases.

Note that, such an operation that after a column has been selected by the horizontal scanning circuit, the pixels belonging to the selected column are successively selected by the vertical scanning circuit can be performed as well depending on the design. In this case, the vertical scanning circuit becomes a high frequency noise source.

### SUMMARY OF THE INVENTION

In the light of the foregoing, the present invention aims at solving the above-mentioned problems associated with the prior art, and it is, therefore, an object of the present invention to provide a solid state image pick-up device which is capable of suppressing an influence exerted on an output video signal by a high frequency noise generated by a scanning circuit.

In order to attain the above-mentioned object, according to the present invention, there is provided a solid state image pick-up device including: a first scanning means; and a second scanning means having a lower driving frequency than that of the first scanning means, the first scanning means and the second scanning means being arranged to be adjacent to different side portions of a chip, respectively, in which a predetermined pad is arranged in at least one of side portions of the chip, except for the side portion on a side where the first scanning means is arranged.

The solid state image pick-up device further includes a pixel region, on the chip, in which pixels having an active element are two-dimensionally arranged, and in the solid state image pick-up device, the predetermined pad includes at least a pad through which a voltage or a ground potential is applied to the active element. The solid state image pick-up device further includes: an amplifier for amplifying signal charges successively read out from the pixels of the pixel region by the first scanning means and the second scanning means, and in the solid state image pick-up device, the predetermined pad includes at least a pad through which a voltage is inputted to the amplifier or an output signal of the amplifier is outputted to the outside of the chip.

According to the present invention as stated above, the pads through which a high frequency noise exerts an influence on an output signal of the chip (predetermined pads), e.g., the pads through which a voltage or the ground potential is applied to the active elements, the pads through which the voltage is applied to the amplifier or the output signals of the amplifiers are outputted to the outside of the chip, and the like are arranged along a side portion, of side portions of the chip, the side portion being provided with no first scanning unit as a high frequency noise source. Consequently, the high frequency noise does not largely exert the influence on the output signal of the chip through the predetermined pads and wirings extending from the pads.

### BRIEF DESCRIPTION OF THE DRAWINGS

FIG. 1 is a block diagram showing a chip configuration of a solid state image pick-up device according to an embodiment of the present invention;

FIG. 2 is a circuit diagram, partly in block diagram, showing a basic circuit configuration of the solid state image pick-up device shown in FIG. 1;

FIG. 3 is a circuit diagram showing a structural example of a unit pixel in a pixel region shown in FIG. 2;

FIG. 4 is a circuit diagram showing a structural example of a memory of a CT memory shown in FIG. 2;

FIG. 5 is a timing chart useful in explaining an operation of the circuits shown in FIG. 2;

FIG. 6A is a block diagram showing an embodiment of a digital camera to which the solid state image pick-up device of the present invention is applied;

FIG. 6B is a front outside view of an example of a digital single-lens reflex camera to which the solid state image pick-up device of the present invention is mounted;

FIG. 7A is a plan view showing a chip structure of a conventional solid state image pick-up device, and

FIG. 7B is a cross sectional view taken along the line 7B-7B of FIG. 7A; and

FIG. 8 is a circuit diagram, partly in block diagram, showing a schematic configuration of a solid state image pick-up element of a MOS (X-Y address) system as an example of a conventional solid state image pick-up device.

### DESCRIPTION OF THE PREFERRED EMBODIMENTS

Next, preferred embodiments of the present invention will hereinafter be described in detail with reference to the accompanying drawings.

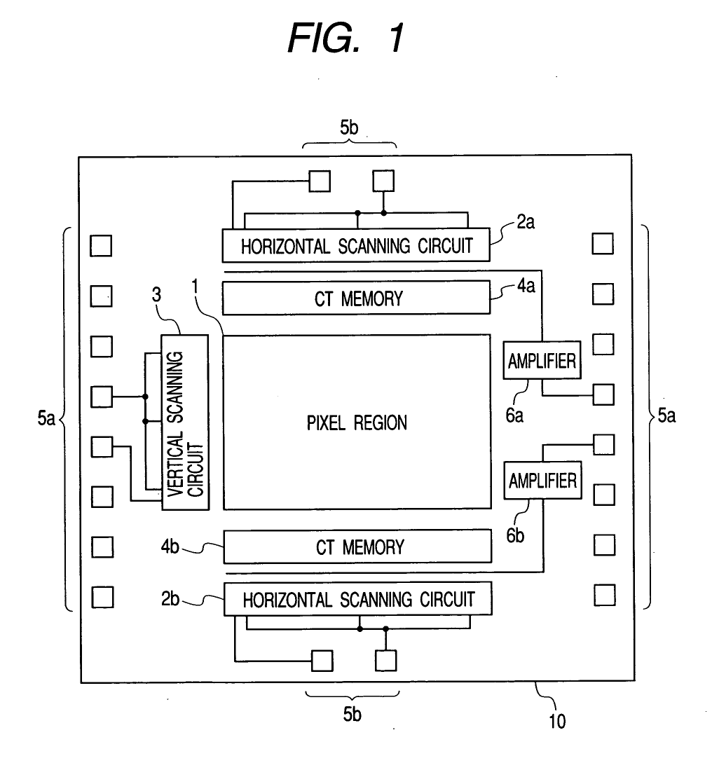

FIG. 1 is a block diagram showing a chip configuration of a solid state image pick-up device according to an embodiment of the present invention. A pixel region 1 having pixels two-dimensionally arranged therein is formed in the vicinity of the center of a chip 10. Horizontal scanning circuits 2a and 2b, a vertical scanning circuit 3, CT memories 4a and 4b, pads 5a and 5b, and amplifiers 6a and 6b are formed on the periphery of the pixel region 1.

The pixel region 1 is formed into a rectangular shape having an aspect ratio (ratio of a length to a width) of 2:3, for example, and includes therein pixels of m rows×n columns. It should be noted that the aspect ratio may be suitably determined in accordance with the application and hence is not intended to be limited to the value in this embodiment. The vertical scanning circuit 3 is composed of a vertical shift register for selecting the pixels of the pixel region 1 on the row basis, and is provided so as to be adjacent to one short side of the pixel region 1. A driving frequency of the vertical scanning circuit 3 is in the range of several kHz to several tens of kHz.

The CT memories 4a and 4b are analog memories for storing therein signal charges transferred from the pixels belonging to a row selected by the vertical scanning circuit 3. The CT memory 4a is provided so as to be adjacent to one long side of the pixel region 1 and serves to store therein the signal charges of the pixels belonging to the odd-numbered columns. On the other hand, the CT memory 4b is provided so as to be adjacent to the other long side of the pixel region 1 and serves to store therein the signal charges of the pixels belonging to the even-numbered columns.

The horizontal scanning circuit 2a is provided so as to be adjacent to the CT memory 4a, and is composed of a horizontal shift register for successively reading out the signal charges of the pixels stored in the CT memory 4a. On the other hand, the horizontal scanning circuit 2b is-provided so as to be adjacent to the CT memory 4b, and is composed of a horizontal shift register for successively reading out the signal charges of the pixels stored in the CT memory 4b. Driving frequencies of those horizontal scanning circuits 2a and 2b are equal to each other, and each of them is several tens of MHz.

The amplifier 6a serves to amplify a signal (voltage) which has been read out from the CT memory 4a by the horizontal scanning circuit 2a. On the other hand, the amplifier 6b serves to amplify the signal charges which have been read out from the CT memory 4b by the horizontal scanning circuit 2b. Those amplifiers 6a and 6b are provided so as to be adjacent to the other short side of the pixel region 1 (short side opposite to the side adjacently to which the vertical scanning circuit 3 is provided).

The plural pads 5a are arranged along opposite side portions, corresponding to the sides of both the short sides of the pixel region 1, of side portions of the chip 10. As for the pads 5a, in addition to the pads through which a signal used to drive the vertical scanning circuit 3 is inputted, there are the pads through which high frequency noises generated by the horizontal scanning circuits 2a and 2b are easy to exert an influence on an output video signal, e.g., the pads through which a voltage or the ground potential is applied to active elements of the pixels, the pads through which voltages are applied to the amplifiers 6a and 6b, respectively, the pads through which output signals of the amplifiers 6a and 6b are outputted to the outside of the chip 10, and the like.

The plural pads 5b are arranged along the side portions adjacently to which the horizontal scanning circuits 2a and 2b are provided, respectively, of the side portions of the chip 10. As for the pads 5b, there are the pads through which the high frequency noises from the horizontal scanning circuits 2a and 2b hardly exert a large influence on an output video signal, e.g., the pads through which signals required to drive the horizontal scanning circuits 2a and 2b are respectively inputted.

In the above-mentioned solid state image pick-up device, first of all, for a blanking period, the signal charges of the pixels belonging to a row selected by the vertical scanning circuit 3 are transferred to the CT memories 4a and 4b to be stored therein, respectively. Thereafter, for a horizontal scanning period, the signal charges stored in the CT memories 4a and 4b are successively read out by the horizontal scanning circuits 2a and 2b, respectively. The signal charges read out from the CT memories 4a and 4b are amplified by the amplifiers 6a and 6b, respectively, to be outputted in the form of a video signal sequence to the outside through the corresponding pads 5a. With respect to the pixels belonging to other rows as well, the signal charges are successively read out in accordance with the same procedure. In such a manner, the signal charges are successively read out along the horizontal line in order from the pixel located at an upper left portion of the pixel region 1.

All the pads through which the high frequency noises are easy to exert an influence on the output video signal, and the wirings connected thereto are arranged in the positions remote from the horizontal scanning circuits 2a and 2b as the high frequency noise sources. Thus, the high frequency noises from the horizontal scanning circuits 2a and 2b do not largely exert the influence on the video signal outputted from the chip 10 through the pads and the wirings. Consequently, a turbulence of an image due to the high frequency noises is not caused.

Next, a basic circuit configuration of the solid state image pick-up device shown in FIG. 1 will hereinbelow be specifically described.

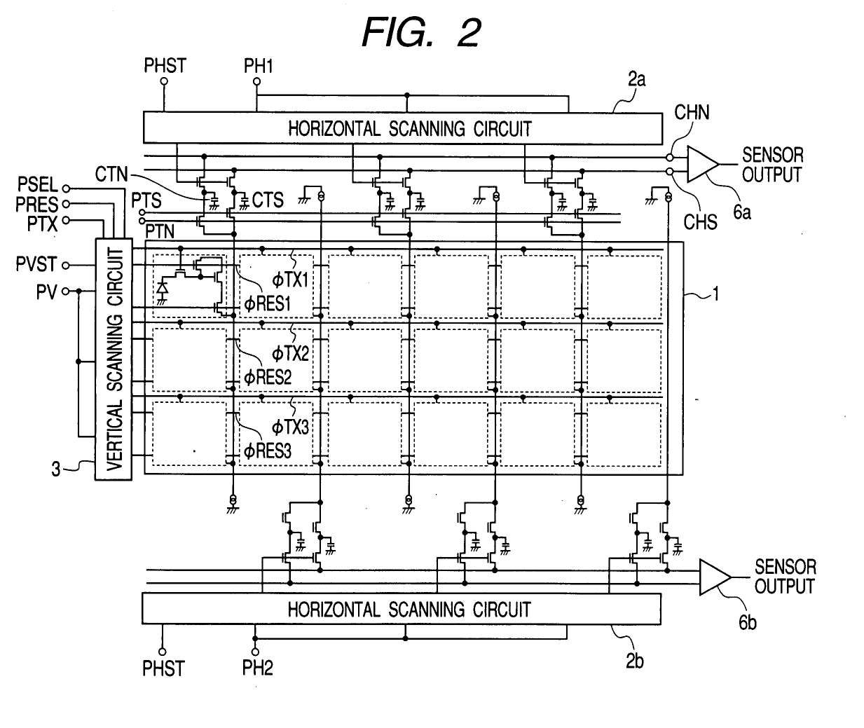

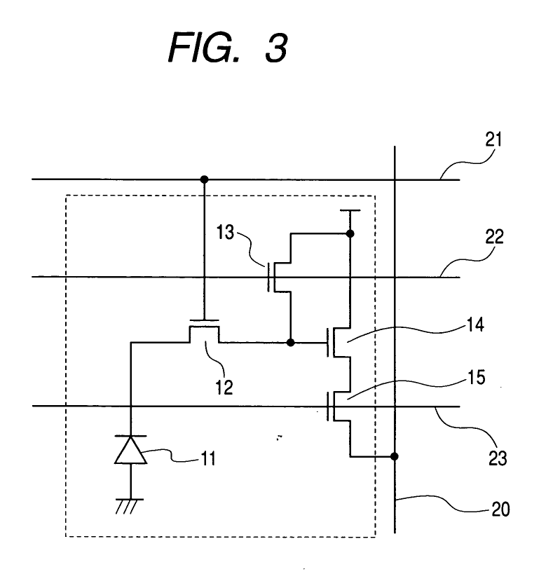

A specific circuit configuration of the pixel region 1, the horizontal scanning circuits 2a and 2b, the vertical scanning circuit 3, and the CT memories 4a and 4b is shown in FIG. 2. The pixel region 1 has a plurality of vertical signal lines 20 which vertically extend, and a plurality of gate lines 21 and a plurality of selection lines 23 which horizontally extend. The pixels (unit pixels) are formed in intersections at which the vertical signal lines 20, and the gate lines 21 and the selection lines 23 intersect each other. The unit pixel, as shown in FIG. 3, includes a photodiode 11, and a transfer MOS transistor 12, a reset MOS transistor 13, a source follower input MOS transistor 14, and a selection MOS transistor 15 as active elements.

A gate of the transfer MOS transistor 12 is operatively connected to the gate line 21 which extends so as to be perpendicular to the vertical signal line 20, a source thereof is operatively connected to an output terminal of the photodiode 11, and a drain thereof is operatively connected to a source of the reset MOS transistor 13 and a gate of the source follower input MOS transistor 14. A gate of the reset MOS transistor 13 is operatively connected to a reset line 22, and a drain thereof is operatively connected to a power supply for supplying a reference voltage. A source of the source follower input MOS transistor 14 is operatively connected to the vertical signal line 20 through the selection MOS transistor 15, and a drain thereof is operatively connected to the power supply. Also, the selection MOS transistor 15 serves as a switch for connecting the source of the source follower input MOS transistor 14 of the pixel belonging to a selected row from which-the signal charges are determined to be read out to the vertical signal line 20.

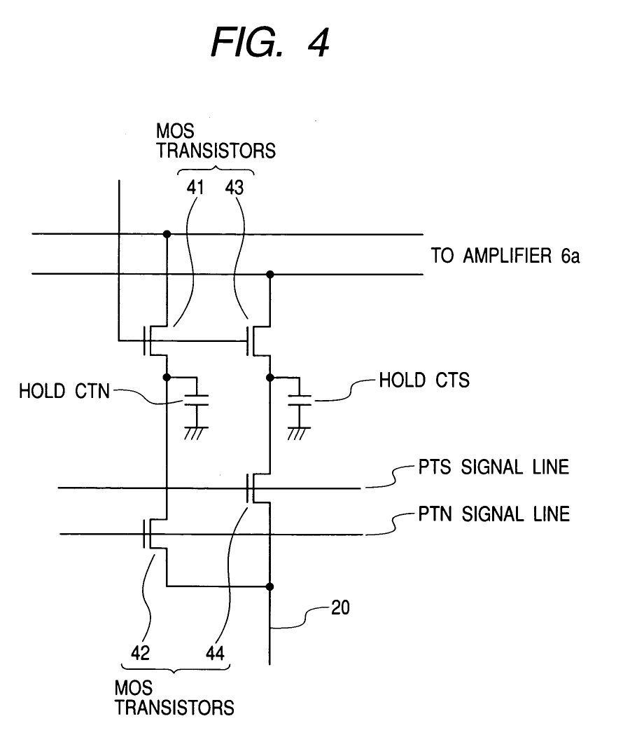

The CT memory 4a has a memory for every vertical signal line 20 to which the pixels belonging to the odd-numbered columns are connected. The memory, as shown in FIG. 4, includes MOS transistors 41 to 44, and hold CTN and CTS.

The hold (capacitance) CTN is a portion for holding therein a reference voltage which is read out before a signal of the photodiode is inputted to the gate of the source follower input MOS transistor 14 by the transfer MOS transistor 12. It should be noted that by the reference voltage is meant an electric potential, corresponding to a power supply operatively connected to the reset MOS transistor 13, right after cancel of reset of the pixel. A source of the MOS transistor 41 and a drain of the MOS transistor 42 are connected to each other. Also, the MOS transistors 41 and 42 connected in series are operatively connected to one branch line branching from the vertical signal line 20. Then, the hold (capacitance) CTN is operatively connected to a connection line of those MOS transistors 41 and 42. A drain of the MOS transistor 41 is operatively connected to one input line of the amplifier 6a, and a gate thereof is operatively connected to the horizontal scanning circuit 2a. A gate of the MOS transistor 42 is operatively connected to a signal line over which a PTN signal is supplied.

On the other hand, the hold CTS is a portion for holding therein a voltage corresponding to the signal charges transferred from the unit pixel. A source of the MOS transistor 43 and a drain of the MOS transistor 44 are connected to each other. Also, the MOS transistors 43 and 44 connected in series are operatively connected to the other branch line branching from the vertical signal line 20. Then, the hold (capacitance) CTS is operatively connected to a connection line of those MOS transistors 43 and 44. A drain of the MOS transistor 43 is operatively connected to the other input line of the amplifier 6a, and a gate thereof is operatively connected to the horizontal scanning circuit 2a. A gate of the MOS transistor 44 is operatively connected to the signal line over which a PTS signal is supplied.

The CT memory 4b has a memory for every vertical signal line 20 to which the pixels belonging to the even-numbered columns are connected. This memory also has the same configuration as that shown in FIG. 4 except that it is connected to the amplifier 6b.

The vertical scanning circuit 3 is operated in accordance with a signal PVST and a signal PV to control turn-ON or OFF of the transfer MOS transistor 12, the reset MOS transistor 13 and the selection MOS transistor 15 in each unit pixel of the pixel region 1 in accordance with a signal PTX, and signals PRES and PSEL.

In each of the CT memories 4a and 4b, the MOS transistor 42 is controlled so as to be turned ON or OFF in accordance with the PTN signal to thereby control the operation for holding the voltage in the hold CTN. Also, the MOS transistor 44 is controlled so as to be turned ON or OFF in accordance with the PTS signal to thereby control the operation for holding the voltage in the hold CTS.

The horizontal scanning circuit 2a is operated in accordance with a signal PHST and a signal PH1 so that the MOS transistors 41 and 43 of the CT memory 4a are controlled so as to be turned ON or OFF.

Likewise, the horizontal scanning circuit 2b is operated in accordance with the signal PHST and a signal PH2 so that the MOS transistors 41 and 43 of the CT memory 4b are controlled so as to be turned ON or OFF.

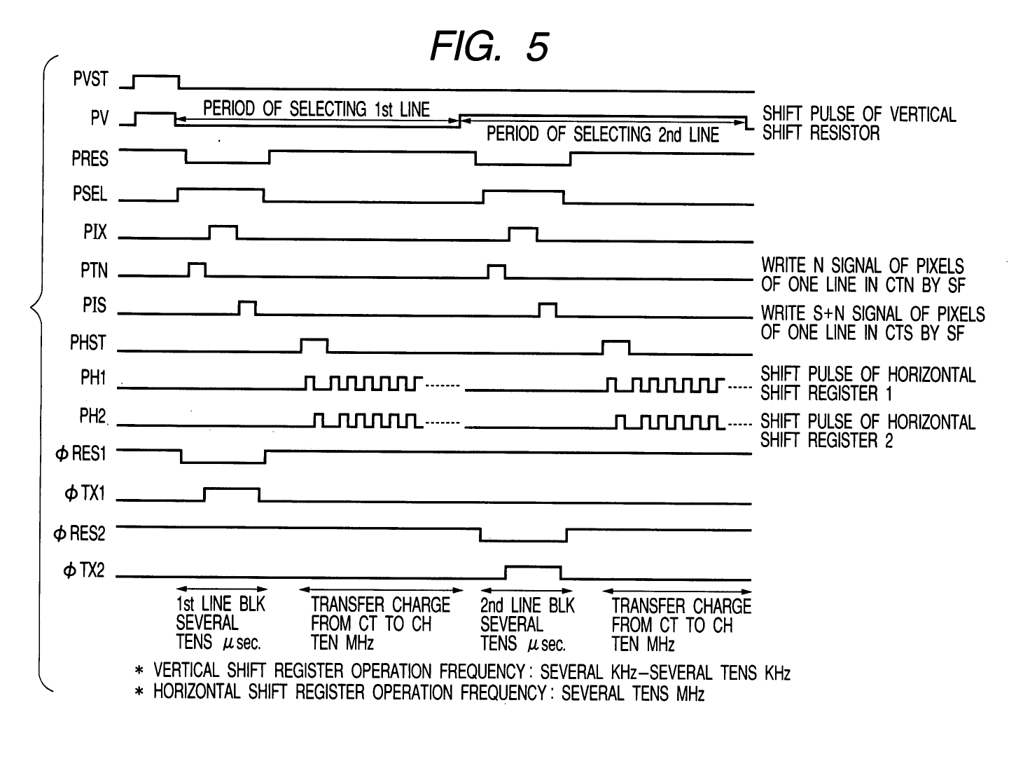

FIG. 5 is a timing chart useful in explaining the operation of the circuit shown in FIG. 2. The operation of the circuit shown in FIG. 2 will hereinbelow be described in detail with reference to FIGS. 2 to 5.

The vertical scanning circuit 3 starts to operate at a rising timing of the signal PVST. The signal PV is a shift pulse of a vertical shift. After a lapse of a fixed period of time from rise of the signal PVST, the signal PV firstly drops to the low level, and thereafter, the high level and the low level are switched over to each other in the signal PV at a predetermined period (frequency is in the range of several kHz to several tens of kHz). Periods of time of the levels correspond to periods of time of selecting rows, respectively, in such a manner that in the switching of the levels, a period of time of a first low level corresponds to a period of time of selecting the first line of the pixel region 1, a period of time of a second high level corresponds to a period of time of selecting the second line of the pixel region 1, and so forth. The signal PRES is held at the low level only for a predetermined period of time after a lapse of a fixed period of time from any timing at which the low level and high level of the signal PV are switched over to each other. This period of time when the signal PRES is held at the low level corresponds to a blanking period (BLK).

In the blanking period for a period of time of selecting the first line, first of all, before the MOS transistors 42 of the CT memories 4a and 4b are turned ON for a period of time when the PTN signal is held at the high level, at a falling timing of a signal ΦRES1 supplied to the reset signal line 22, the reset MOS transistors 13 of the pixels belonging to the first line are turned OFF to release a reset state. As a result, an electric potential, corresponding to a power supply (reference voltage) connected to the reset MOS transistor 13, right after release of the reset state is held in the hold CTNs of the memories of the CT memories 4a and 4b.

Subsequently, after the MOS transistors 42 of the memories of the CT memories 4a and 4b are turned OFF at a timing of fall of the PTN signal, for a period of time when the signal PTX is held at the high level, the transfer MOS transistors 12 of the pixels belonging to the first line are turned ON. After a lapse of a fixed period of time, at a timing of fall of the signal PTX, after the transfer MOS transistors 12 of the pixels are turned OFF, the PTS signal reaches the high level to turn ON the MOS transistors 44 of the memories of the CT memories 4a and 4b. As a result, electric potentials which are obtained in the form of voltages corresponding to optical signals accumulated through the photoelectric conversion of the photodiodes 11 of the pixels to be held in the hold CTSs and which are superimposed on the reference voltage are held in the hold CTSs of the CT memories 4a and 4b.

Subsequently, at a timing of fall of the PTS signal, the MOS transistors 44 of the memories of the CT memories 4a and 4b are turned OFF, and thereafter, at a timing of rise of the signal ΦRES1, the reset MOS transistors 13 are turned ON again. As a result, a reset state is started to complete the blanking period.

The reference electric potential (electric potential obtained by accumulating the charges in correspondence to the reference voltage right after reset) of the pixels, belonging to the odd-numbered columns, of the pixels belonging to the first line, and the electric potentials corresponding to the charges containing the optical signals thereof are respectively held in the hold CTNs and the hold CTSs in the memories of the CT memory 4a through the above operation. Likewise, the reference electric potential of the pixels, belonging to the even-numbered columns, of the pixels belonging to the first line, and the electric potentials corresponding to the charges containing the optical signals thereof are respectively held in the hold CTNs and the hold CTSs in the memories of the CT memory 4b.

After completion of the blanking period, the horizontal scanning circuits 2a and 2b start to operate at a timing of rise of a signal PHST to carry out the reading operation as will be described below.

At the same time that the horizontal scanning circuit 2a successively controls turn-ON or OFF of the MOS transistors 41 and 43 of the memories of the CT memory 4a in accordance with the signal PH1 (shift pulse of the horizontal shift register), the horizontal scanning circuit 2b successively controls turn-ON or OFF of the MOS transistors 41 and 43 of the memories of the CT memory 4b in accordance with a signal PH2 (shift pulse of the horizontal shift register). Upon turning the MOS transistors 41 and 43 ON, the voltages corresponding to the electric potentials which are held in the hold CTNs and the hold CTSs are supplied to the input lines of the amplifiers 6a and 6b, respectively. Each of the amplifiers 6a and 6b outputs the results of differential amplification of both the input signals, i.e., subtracts the reference voltage from the optical signal superimposed on the reference electric potential to thereby output the optical signal. Thus, the optical signal charges (signal charges of the pixels belonging to the first line) held in the memories of the CT memories 4a and 4b are successively read out to be amplified by the amplifiers 6a and 6b, respectively, to be outputted in the form of video signal sequence through the above operation.

In periods of time of selecting the second line and its subsequent lines as well, the same operation as that described above is carried out, and hence, finally, (serial) video signals for one frame (or a field) are outputted from the amplifiers 6a and 6b. As shown in FIG. 5, the signal PH1 and the signal PH2 as the shift pulses of the horizontal scanning circuits 2a and 2b have the same frequency (several tens of MHz), and finally, a series of video signals are obtained from the signals outputted from the amplifiers 6a and 6b.

The solid state image pick-up device of this embodiment described above is merely shown by way of example, and hence its configuration can be suitably changed in accordance with a design. For example, the pads 5a may be arranged on one of the side portion on the side along which the vertical scanning circuit 3 of the chip 10 is arranged, and the side portion opposite thereto.

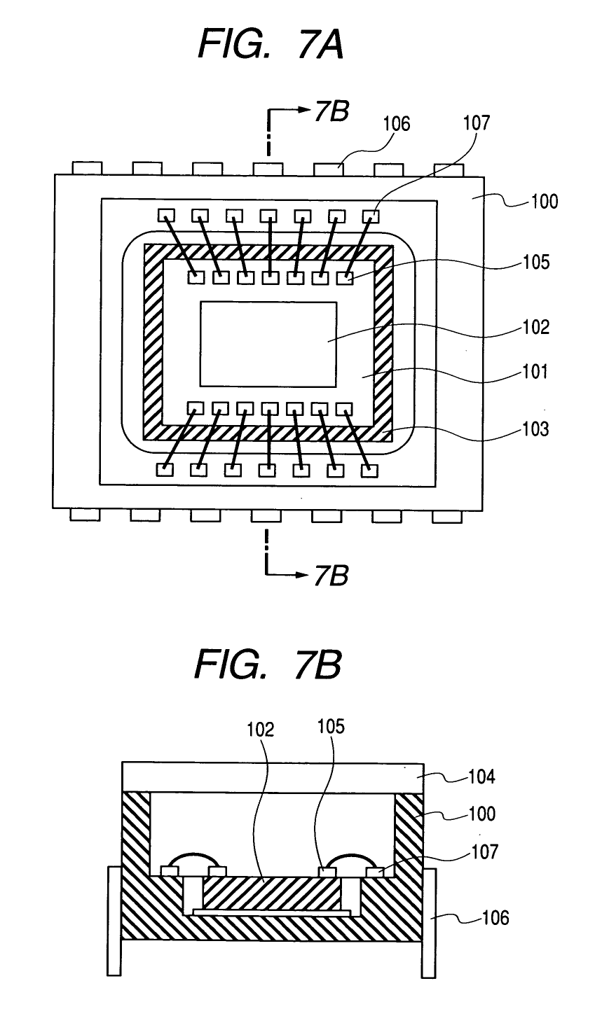

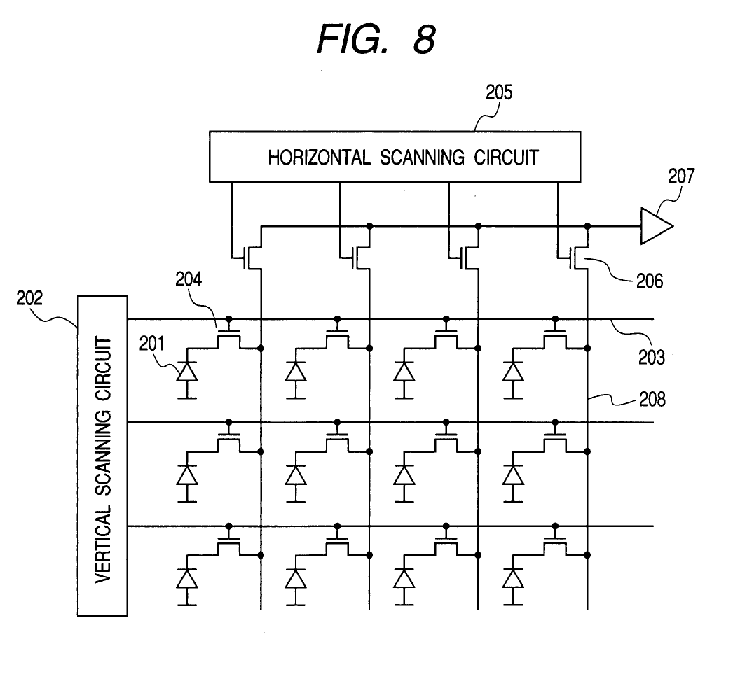

In addition, it should be noted that the present invention is not intended to be limited to the constitution described above. That is to say, the present invention may also be applied to any type of device as long as it includes scanning circuits having different driving frequencies, and the scanning circuit having a higher driving frequency becomes a high frequency noise source so that the high frequency noise generated therefrom exerts an influence on an output signal of a chip through pads and wiring connected thereto. For example, the present invention may also be applied to a device having a circuit shown in FIGS. 7A and 7B. In this case, pads through which a high frequency noise exerts an influence on a video output signal are arranged along at least one of side portions, of side portions of a chip, except for side portions on the side where horizontal scanning circuits are arranged. In addition thereto, the present invention may also be applied to a device in which a CCD is used for transfer of signal charges in a light receiving unit. Moreover, the present invention is effective for use in any of semiconductor devices (display device and the like) as well other than the solid state image pick-up device.

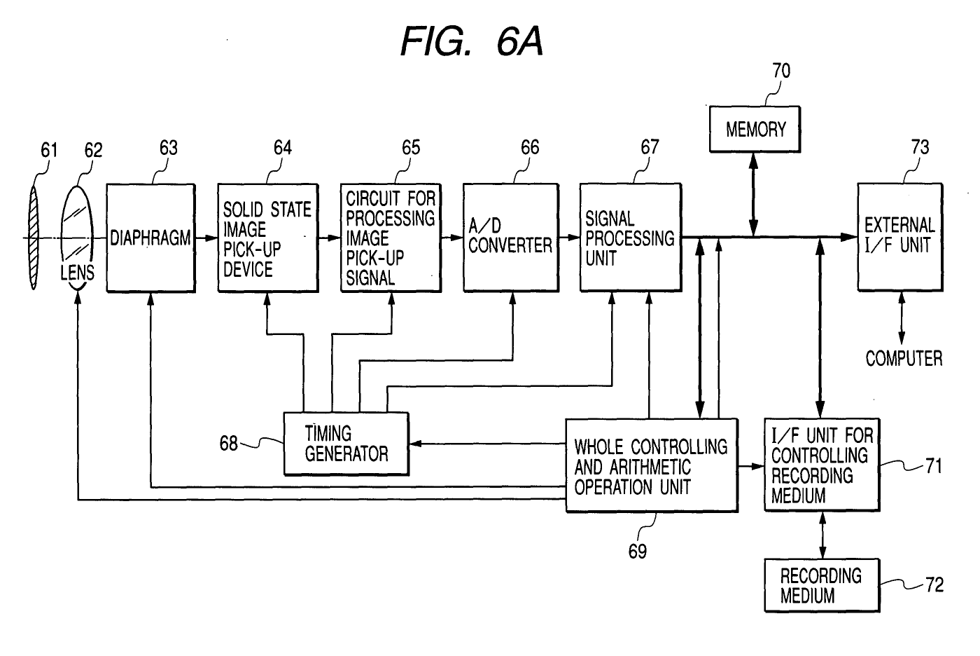

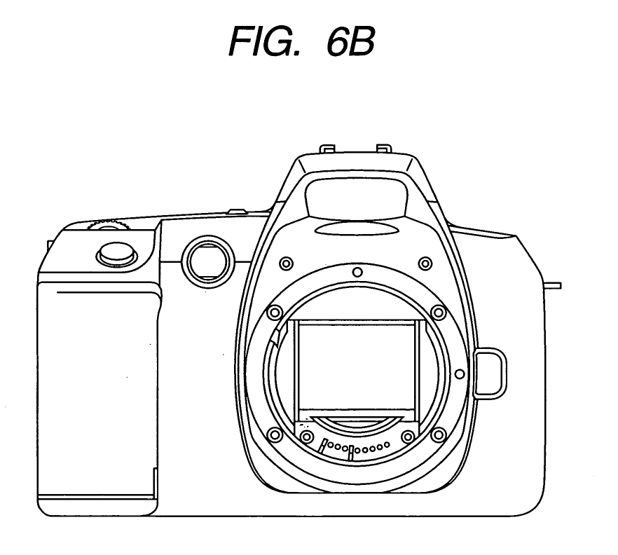

Furthermore, an embodiment in a case where the solid state image pick-up device of the present invention is applied to a digital camera will hereinbelow be described in detail with reference to FIGS. 6A and 6B.

FIG. 6A is a block diagram showing “a digital camera” to which the solid state image pick-up device of the present invention is applied.

In FIG. 6A, reference numeral 61 designates a barrier serving both as a protector and a main switch of a lens; 62, the lens for forming an optical image of a subject on a solid state image pick-up device 64; 63, a diaphragm for making a quantity of light passing through the lens 62 variable; 64, the solid state image pick-up device 64 of the present invention for capturing an image of a subject imaged through the lens 2 in the form of an image signal; 65, a circuit for processing an image pickup signal; 66, an A/D converter for A/D converting an image signal outputted from the solid state image pick-up device 64; 67, a signal processing unit for carrying out various kinds of corrections for image data outputted from the A/D converter 66 or for compressing data; 68, a timing generator for outputting various kinds of timing signals to the solid state image pick-up device 64, the circuit 65 for processing the image pickup signal, the A/D converter 66, and the signal processing unit 67; 69, a whole controlling and arithmetic operation unit for carrying out various kinds of arithmetic operations and for controlling the whole still video camera; 70, a memory for temporarily storing therein image data; 71, an I/F unit for controlling a recording medium, which is adapted to record or read out image data on or from the recording medium; 72, the detachably attachable recording medium, such as a semiconductor memory, in or from which image data is recorded or read out; and 73, an external I/F unit for communicating with an external computer or the like.

Next, the operation of the still video camera having the above-mentioned configuration during photographing will hereinbelow be described in detail.

Upon open of the barrier 1, a main power supply is turned ON, and next, a control system power supply is turned ON, and also a power supply for image pickup system circuits including the A/D converter 66 and the like is turned ON. Thereafter, in order to control exposure, the whole controlling and arithmetic operation unit 69 opens the diaphragm 63. Then, after a signal outputted from the solid state image pick-up device 64 is A/D-converted by the A/D converter 66, the resultant digital signal is inputted to the signal processing unit 67. The whole controlling and arithmetic operation unit 69 carries out the arithmetic operation for the exposure on the basis of the data obtained from the signal processing unit 67. Then, the whole controlling and arithmetic operation unit 69 judges brightness on the basis of the results of carrying out photometry to control the diaphragm 63 in accordance with the judgement results.

Next, high frequency components are taken out and also the arithmetic operation for measurement of a distance up to the subject is carried out in the whole controlling and arithmetic operation unit 69 on the basis of a signal outputted from the solid state image pick-up device 64. Thereafter, the lens is driven to judge whether or not the image is focused. If it is judged that the image is not yet focused, then the lens is driven again to remeasure the distance. Then, after it is confirmed that the image is focused, the real exposure is started. After completion of the exposure, the image signal outputted from the solid state image pick-up device 64 is A/D-converted in the A/D converter 66 to pass through the signal processing unit 67 to be written to the memory 70 by the whole controlling and arithmetic operation unit 69. Thereafter, the data stored in the memory 70 passes through the I/F unit 71 for controlling the recording medium to be recorded on the detachably attachable recording medium 72 such as a semiconductor memory in accordance with the control made by the whole controlling and arithmetic operation unit 69. The image data may pass through the external I/F unit 73 to be directly inputted to a computer or the like in order to process an image.

In addition, FIG. 6B is a front outside view of an example of a digital single-lens reflex camera to which the solid state image pick-up device of the present invention is mounted.

As set forth hereinabove, according to the present invention, it is possible to suppress the influence exerted on the output video signal due to the high frequency noise from the scanning circuit having the higher driving frequency, whereby an image can be provided, which is of higher image quality than that in the prior art.

What is claimed is:

1. A solid state image pick-up device comprising:
a first scanning means; and
a second scanning means having a lower driving frequency than that of the first scanning means, the first scanning means and the second scanning means being arranged to be adjacent to different side portions of a chip, respectively,
wherein a predetermined pad is arranged in at least one of side portions of the chip, except for the side portion on a side where the first scanning means is arranged.

2. A solid state image pick-up device according to claim 1, further comprising a pixel region, on the chip, in which pixels having an active element are two-dimensionally arranged,
wherein the predetermined pad includes at least a pad through which a voltage or a ground potential is applied to the active element.

3. A solid state image pick-up device according to claim 2, wherein the active element comprises at least one selected from the group consisting of a transfer MOS transistor, a reset MOS transistor, a source follower input MOS transistor, and a selection MOS transistor.

4. A solid state image pick-up device according to claim 1, further comprising:
a pixel region, on the chip, in which pixels having an active element are two-dimensionally arranged; and
an amplifier for amplifying signal charges successively read out from the pixels of the pixel region by the first scanning means and the second scanning means,
wherein the predetermined pad includes at least a pad through which a voltage is inputted to the amplifier or an output signal of the amplifier is outputted to the outside of the chip.

5. A solid state image pick-up device according to claim 2, wherein the pixel region is formed into a rectangle, and the first scanning means is arranged closer to a long side of the pixel region.

6. A solid state image pick-up device according to claim 5, wherein the plurality of first scanning means are arranged to sandwich therebetween the pixel region.

7. A solid state image pick-up device according to claim 2, wherein the first scanning means comprises a horizontal shift register, and the second scanning means comprises a vertical shift register.

8. A camera, comprising:
the solid state image pick-up device according to claim 1;
a lens for forming an optical image of a subject; and
a signal processing unit for processing a signal from the solid state image pick-up device.
